(19) United States
(12) Patent Application Publication
(10) Pub. No.: US 2012/0072381 A1
(43) Pub. Date: Mar. 22, 2012

(54) Method and Apparatus for Segmenting Context Information

(75) Inventors: Huanhuan CAO, Beijing (CN); Jilei TIAN, Beijing (CN)

(73) Assignee: NOKIA CORPORATION, Espoo (FI)

(21) Appl. No.: 13/236,461

(22) Filed: Sep. 19, 2011

(30) Foreign Application Priority Data
Sep. 17, 2010 (CN) PCT/CN2010/077047

(51) Int. Cl. G06F 15/18

(52) U.S. Cl. 706/12

(57) ABSTRACT

An approach is provided for segmenting context information. A context segmenting platform determines context information associated with a device. The context segmenting platform determines context information associated with a device. The context segmenting platform then determines one or more context patterns based, at least in part, on the context information and determines one or more transition points between the one or more context patterns. Based, at least in part, on the one or more transition points, the context segmenting platform determines to segment the context information.

### RELATED APPLICATION

This application claims priority benefit to Patent Cooperation Treaty Application Number PCT/CN2010/077047, filed Sep. 17, 2010, and is herein incorporated by reference, in its entirety.

### BACKGROUND

Service providers (e.g., wireless and cellular services) and device manufacturers are continually challenged to deliver value and convenience to consumers by, for example, providing compelling network services and advancing the underlying technologies. One of interest has been the development of services and technologies for characterizing user behavior with respect to the user's interactions with a device (e.g., a cell phone, smartphone, or other mobile device). More specifically, characterizing user behavior relies, for instance, on collecting a stream of context information (e.g., location, time, date, activity, etc.) and then determining context or behavior patterns from the context information. However, service providers and device manufacturers face significant technical challenges in making such determinations, particularly on mobile devices, because segmenting the stream of context information into discernible patterns are often very resource intensive (e.g., processing resources, memory resources).

### SOME EXAMPLE EMBODIMENTS

Therefore, there is a need for an approach for efficiently segmenting context information.

According to one embodiment, a method comprises determining context information associated with a device. The method also comprises determining one or more context patterns based, at least in part, on the context information. The method further comprises determining one or more transition points between the one or more context patterns. The method further comprises determining to segment the context information based, at least in part, on the one or more transition points.

According to another embodiment, an apparatus comprising at least one processor, and at least one memory including computer program code, the at least one memory and the computer program code configured to, with the at least one processor, cause, at least in part, the apparatus to determine context information associated with a device. The apparatus is also caused to determine one or more context patterns based, at least in part, on the context information. The apparatus is further caused to determine one or more transition points between the one or more context patterns. The apparatus is further caused to determine to segment the context information based, at least in part, on the one or more transition points.

According to another embodiment, a computer-readable storage medium carrying one or more sequences of one or more instructions which, when executed by one or more processors, cause, at least in part, an apparatus to determine context information associated with a device. The apparatus is also caused to determine one or more context patterns based, at least in part, on the context information. The apparatus is further caused to determine one or more transition points between the one or more context patterns. The apparatus is further caused to determine to segment the context information based, at least in part, on the one or more transition points.

According to another embodiment, an apparatus comprises means for determining context information associated with a device. The apparatus also comprises means for determining one or more context patterns based, at least in part, on the context information. The apparatus further comprises means for determining one or more transition points between the one or more context patterns. The apparatus further comprises means for determining to segment the context information based, at least in part, on the one or more transition points.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of segmenting context information, according to one embodiment;

FIG. 2 is a diagram of the components of context segmenting platform, according to one embodiment;

FIG. 3 is a flowchart of a process for segmenting context information, according to one embodiment;

FIG. 4 is a flowchart of a process for tagging segmented context information, according to one embodiment;

FIG. 5 is a flowchart of a process for context prediction using segmented context information, according to one embodiment;

FIG. 6 is a diagram depicting a vector-based process for segmenting context information, according to one embodiment;

FIGS. 7A and 7B are diagrams of interactions between a client and a server utilized in data mining included in the processes of FIGS. 3-5, according to various embodiments;

FIGS. 8A-8E are diagrams of user interfaces at a client end utilized in the processes of FIGS. 3-5, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for segmenting context information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention. Although various embodiments are described with respect to a mobile device, it is contemplated that the approach described herein may be used with any other device that supports and maintains a user interaction history and context data.

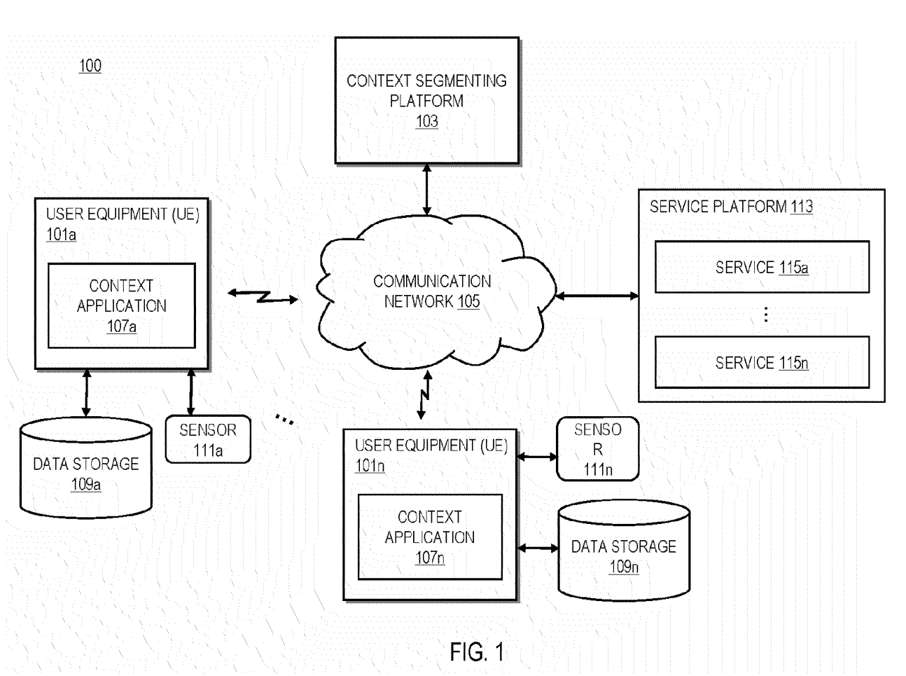

FIG. 1 is a diagram of a system capable of segmenting context information, according to one embodiment. Personalized context-aware systems generally learn a user's typical context or situations (e.g., “in a cinema,” “in a book store,” “driving,” etc.) through, for instance, a context recognition model. Once the context recognition model has been trained, a system can use it to recognize the user's personal contexts and then, for example, take actions according to context-aware rules predefined by the user or generated from a knowledge base. In some embodiments, context recognition models have universal applicability and may be shared among the general population of users. An example of such a context recognition model is a model for transportation status detection from the 3D accelerometer data. However, there are still many context recognition models which are naturally personalized, such as significant place detection (e.g., a favorite pub, a square near home, etc.) or social activity detection (e.g., on the way to office, having a class, etc.). This kind of personalized context recognition models generally are based on the raw context data of the specific user with user-specified labels or tags as the training data.

However, the dilemma is that on the one hand most of personalized context recognition models often cannot obtain acceptable performance when there are only a few specified labels, and on the other hand, users often find it inconvenient to manually label or tag the amount of raw context information or data needed for training. As a result, many personalized context recognition models do not have sufficient labeled context information to provide accurate or consistent results. This, in turn, discourages users from relying on such context recognition models.

Fortunately, a mobile user's context usually changes for limited times in one day, if the user can label the time points of context transitions, all of the context data are labeled indirectly. For example, suppose the one clay's context transition sequence of a user as follow: home->waiting bus->on bus->office-> . . . restaurant->pub->home, several labels of context transition points can derive hundreds of labeled raw context data records for training a context recognition model.

To address this problem, a system 100 of FIG. 1 introduces the capability to segment context information or data (e.g., context records) based on determining one or more transition points that represent when the context information changes from one context pattern to another. In one embodiment, either the system 100 can then determine context labels or tags for the transition points. In addition or alternatively, a user can manually specify the context labels or tags. It is noted that a user's context or context pattern typically changes only a limited number of times in one day. In other words, even though context information may be sampled or collected at a relatively high frequency throughout the day, the context information itself changes only a few times in the day. For example, a context transition sequence of a user over a typical can be as follows: home->waiting bus->on bus->office-> . . . restaurant->pub->home. Accordingly, several labels or tags of context transition points can derive hundreds of labeled raw context data records for training a context recognition model, thereby advantageously reducing the burden on users to manually label the context data records.

In one embodiment, a context record includes, at least in part, all context data and interaction data (e.g., date, time of day, location, activity, etc.) collected at a specific time. By way of example, the context record may contain or describe several contexts wherein each context is a subset of the context data included in the context record. For example, given a context record including a time, context data, and interaction data, e.g., [time=t1, Context Data=<(Work Day), (Evening), (High Speed), (High Audio Level)>, Interaction=Play Games], various combinations or permutations of the context data can yield various contexts such is (1) <(Evening)>, (2) <High Speed>, (3) <(Work Day), (Evening)>, etc. As noted, it is contemplated that a context can be any subset of the context data arranged in any combination, which can then be organized as context groups or patterns.

As described above, the system 100 can automatically determine the context patterns associated with individual context records based, at least in part, on the labeling of the determined context transition points. In more detail, the system 100 enables effective segmentation of raw context information by concentrating primarily on the identifying and labeling the transition points. In one embodiment, the context information or records between the transition points can be automatically labeled according to the corresponding transition point. As discussed previously, the context information is generally continuous over time and is volatile, whereas the transition points are relatively sparse over time. For example, when both the context information or records are organized by timestamps representing different time intervals over a period of time, there may be many instances the pattern of the context information remains relatively stable in one pattern (e.g., indicating that the user is engaged associated with a particular context such as “waiting for a bus”) and then transition to another pattern (e.g., “riding on the bus”). Thus, the system 100 determines the context patterns, the transition points between the context patterns, and the time ranges over which the context patterns occur. The system 100 then automatically segments and labels the context information accordingly by, for instance, placing the continuously recorded context information into defined context patterns.

In some embodiments, the system 100 generates a vector to represent the probability that any particular context record matches a given context pattern. More specifically, the system 100 determines a total number of possible context patterns indicated in the context information. The system 100 then generates a multi-dimensional vector with each dimension representing one of the possible context patterns. An individual context record is then mapped onto the vector wherein each dimension of the vector reflects the probability that the particular context record matches the context record corresponding to the dimension. The transition points are then determined from analysis of the vectors. It is also contemplated that the system 100 need not transform the context information into vectors and, instead, may determine the transition points directly from the context record themselves. However, in some cases, use of vectors enables the system 100 to extract certain high level features of the context data records to avoid the influence of noisy or inconsistent data.

Therefore, an advantage of this approach is that, by segmentation and labeling of context information based on identified transition points, the system 100 can automatically generate more labeled context information than using manual (e.g., user labeled) processes. The labeled context information can then be used to provide a more accurate characterization of user behavior. As a consequence of the more accurate characterization, additional services, content, advertising, personalization options, recommendations, etc. can be targeted to the user that may be of greater relevance or interest to the user. For example, when the system 100 determines a relevant context segment associated with a particular user or user device, the determined context segment can then be used to trigger delivery and/or presentation of customized advertising, content, applications, functions, etc. Moreover, in some embodiments, the context segmentation can be used to predict patterns of user behavior or intentions with respect to a device. This predictive function can then be used for statistical or rule mining to further tailor advertising, content, applications, functions, etc. This more precise targeting can, in turn, reduce the amount of unwanted or irrelevant actions, information, or a combination thereof that are initiated or provided to the user, thereby also advantageously reducing the bandwidth, memory, and computational resources associated with such actions. Therefore, means for segmenting and labeling context information based transition points within the context information are anticipated.

As shown in FIG. 1, the system 100 comprises a user equipment (UE) 101 having connectivity to a context segmenting platform 103 via a communication network 105. In the example of FIG. 1, the context segmenting platform 103 collects context information (e.g., context data records and/or user interaction history) from the UE 101 for determining transition points between context patterns corresponding to the user associated with the UE 101. As described above, in one embodiment, the context segmenting platform 103 arranges the context data or records according to the timestamp of each record and determines one or more context patterns from the context information. The platform 103 then analyzes the context patterns or context information to determine transitions points for segmenting the context information.

In certain embodiments, the UE 101 may include a context application 107 for interacting with the context segmenting platform 103 to perform one or more functions of the context segmenting platform 103. For example, the context application 107 may collect context data and user interaction data for use by the context segmenting platform 103. More specifically, the context application 107 can interact with one or more sensors 111 (a sound recorder, light sensor, global positioning system (GPS) device, temperature sensor, motion sensor, accelerometer, and/or any other device that can be used to collect information about the surrounding environments associated with the UE 101) to collect the context data. The UE 101 can then store the collected data in, for instance, the data storage 109.

In one embodiment, the context application 107 and the context segmenting platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

In another embodiment, the context application 107 can operate independently of or without the presence of the context segmenting platform 103. In this way, the context application 107 can perform some or all of the functions of the context segmenting platform 103 without transmitting any information to the platform 103, thereby decreasing any potential exposure of the context data and interaction data to external entities. Accordingly, although various embodiments are described with respect to the context segmenting platform 103, it is contemplated that the functions of the platform 103 can also be performed by the context application 107 or other component of the system 100.

In one embodiment, the context segmenting platform 103 and/or the context application 107 have connectivity to the context data available from, for instance, the service platform 113 which includes one or more services 115a-115n (e.g., weather service, location service, mapping service, media service, etc.). By way of example, these services 115 can provide additional information on environmental conditions (e.g., weather), activities (e.g., playing online games), preferences (e.g., musical preferences), location (e.g., location tracking service), etc. that can provide related context information associated with the UE 101 or the user of the UE 101.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the context segmenting platform 103, and the service platform 113 with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

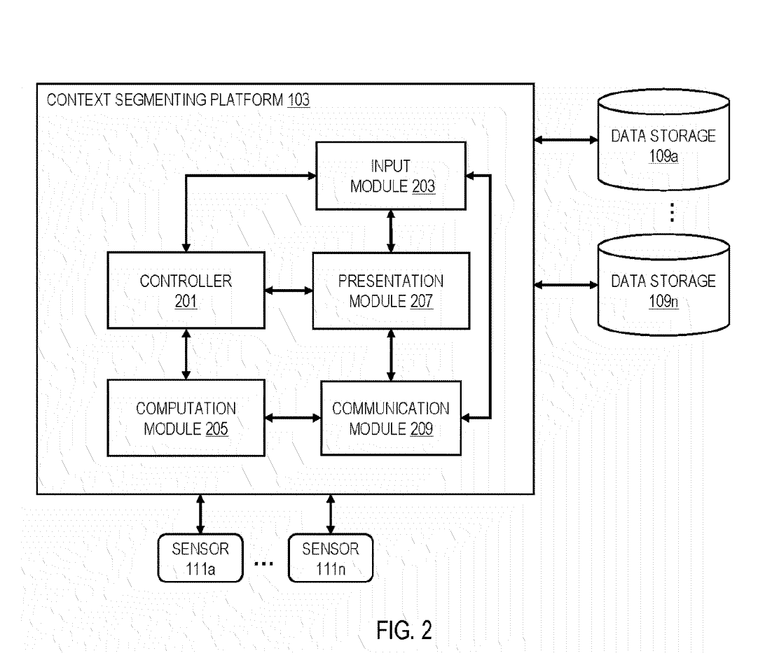

FIG. 2 is a diagram of the components of the context segmenting platform 103, according to one embodiment. By way of example, the context segmenting platform 103 includes one or more components for segmenting context information based, at least in part, on one or more identified transitions points within the context information. It is contemplated that the functions of these components may be combined in one or more components or performed by other components of equivalent functionality. In this embodiment, the context segmenting platform 103 includes a control module 201, an input module 203, a computation module 205, a presentation module 207 and a communication module 209. The control module 201 oversees tasks, including tasks performed by the control module 201, the input module 203, the computation module 205, the presentation module 207 and the communication module 209. The input module 203 manages and communicates an input into the UE 101, and also communicates information acquired by the sensor modules 111a-111n. The input into the UE 101 may be in various forms including pressing a button on the UE 101, touching a touch screen, scrolling through a dial or a pad, etc. The information acquired by the sensor module 111a-111n may be in various types of data form or an electrical signal that is converted into a data form by the input module 203. Some of the information handled by the input module 203 may be used as context records or interaction data, depending on the type of data. Thus, the input module 203 may receive context records and the interaction data from the device. In one embodiment, the context records and interaction data comprise context information.

The computation module 205 performs computations to determine context patterns, transition points between the context patterns, and segments of the context information. For example, the computation module 205 determines one or more context patterns based, at least in part, on the context information and then determines one or more transition points between the one or more context patterns. Next, the computation module 205 determines to segment the context information based, at least in part, on the one or more transition points. In one embodiment, the computation module 205 arranges the context information and determined transition points according to any associated timestamps, and labels the context information based on the context labels or tags associated with the transition points. In one embodiment, the computation module 205 also determines to generate one or more vectors based, at least in part, on the one or more context patterns and then determines to map the context information to the one or more vectors.

In one embodiment, after segmenting of the context information, the control module 201 can interact with the presentation module 207 to, for instance, present a user interface displaying the determined segments or transition points, types of context data and user interaction data used in computing the behavior pattern, and/or the like. In other embodiments, no presentation of the segmented context information is displayed directly to the user. Instead, the segmented context information can be used to make recommendations, suggestions, etc. for personalizing services, content, applications, etc. to the user. The segmented context information and associated context patterns may also be used to target service offerings or other advertisements that are more likely to be of interest or relevance to the user.

The UE 101 may also be connected to storage media such as the data storage media 109a-109n such that the context segmenting platform 103 can access or store the segmented context information and related information in the data storage media 109a-109n. If the data storage media 109a-109n are not local to the platform 103, then storage media 109a-109n may be accessed via the communication network 105. The UE 101 and/or the platform 103 may also be connected to the service platform 113 via the communication network 105 to access context data provided by the services 115a-115n.

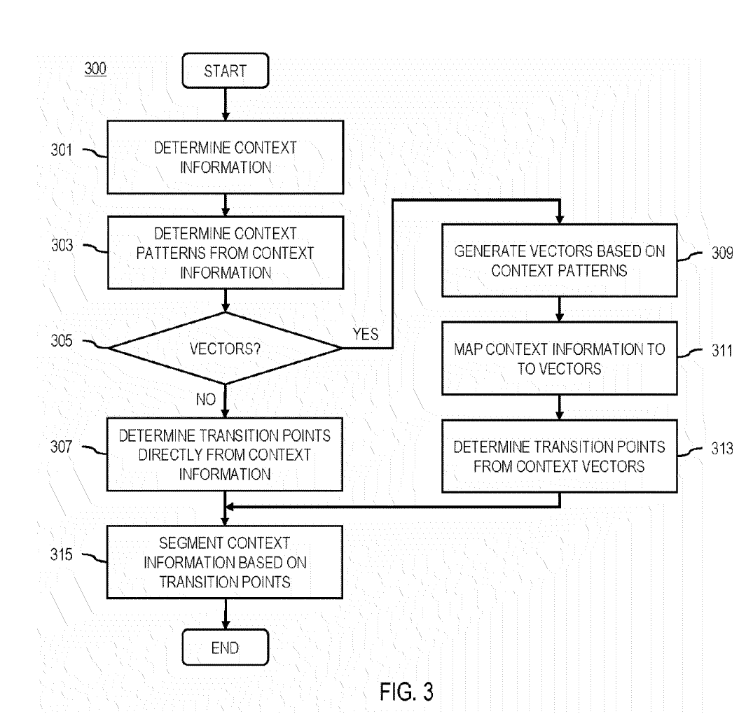

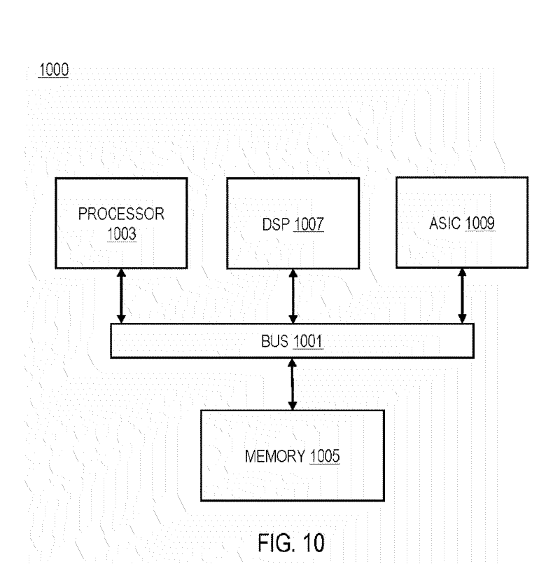

FIG. 3 is a flowchart of a process for segmenting context information, according to one embodiment. In one embodiment, the context segmenting platform 103 performs the process 300 and is implemented in, for instance, a chip set including a processor and a memory as shown FIG. 10. In addition or alternatively, the process 300 may be wholly or partially performed by the context application 107.

In step 301, the context segmenting platform 103 determines context information associated with a UE 101 or a user of the UE 101. By way of example, the context segmenting platform 103 receives or otherwise collects the context information from the user or the UE 101 as one or more context records. In one embodiment, the context records may be obtained by recording context features at a predetermined frequency over a period of time. For example, in some embodiments, the raw context data record is represented by contextual feature value pairs, such as (Cell ID=2301), (Speed=High), (Activity=Stationary), (Location=Office), etc. Moreover, the context features may be recorded every specific time interval, or every time a specific event occurs. In one embodiment, the context records may be obtained from the UE 101, the sensor 111, the service platform 113, or similar component available over the communication network 105. By way of example, the context record may include context features such as time and day, which can be obtained directly from the UE 101. The context record may also include context features such as location information, speed, an audio level and temperature as well as other environmental conditions, which may be collected via a sensor such as a Global Positioning System (GPS) device, an accelerometer, a sound detector, and a temperature sensor. Further, the context record may include context features such as weather information, stock information, and etc., which can be retrieved from the service platform 113, as well as a profile of the user or any other information that may be set within the UE 101. In one embodiment, the context features or elements to include in each of the context records can be determined by, for instance, the service provider, network operator, content provider, advertiser, user, or a combination thereof.

In step 303, the context segmenting platform 103 determines one or more context patterns based, at least in part, on the context information. In other words, the context information or data can be used as training data to learn the context patterns of the user. In one embodiment, the term “context pattern” refers to a group of raw context data or records which may represent some meaningful contexts together. For example, the context pattern {(Is work day?=True), (Time=8:00 AM˜9:00 AM), (Location=Bus station), (Is moving?=False)} implies a typical context that the user is waiting a bus for going to his office. In one embodiment, the context patterns may be any combination of the context features included in the context records. For example, for a context record including location information, speed, an audio level and temperature as context features, the context may be any combination of the location information, the speed, the audio level and the temperature. The context patterns may be determined automatically by an algorithm or a setting in the UE 101, or the user may define the context patterns. For example, the user may specify the number of context features to be included in each context pattern.

In one embodiment, the context segmenting platform 103 may use clustering-based algorithms for finding context patterns from the history context data. By way of example, a typical method is a Latent Dirichlet Allocation Clustering (LDAC) model or a K-means approach. For example, in one clustering approach, the platform 103 determines context patterns based at least in part on the similarity (e.g., topical or semantic similarity) of chronologically adjacent context records. In other words, the context segmenting platform 103 groups context information or records together that have similar context feature values and that occur in adjacent time periods. In this way, the platform 103 can identify context patterns that emerge from the grouped or clustered context records. For example, if a context feature of interest is weather, the platform 103 samples weather data over a period of time and identifies during what time range the weather data indicates is in one state or context (e.g., raining). When the weather changes state (e.g., stops raining), the sequence ends. Therefore, the entire time sequence during which it is raining is grouped into one or more possible context patterns. If the weather becomes sunny, the platform 103 can determine that another context pattern (e.g., sunny) is present in the context information. This process is repeated to identify occurrences of other context patterns potentially in the context information.

Although the above example is described with respect to clustering based on a single context feature or element (e.g., weather), it is contemplated that determination of context patterns may be based on any number of context features. By way of example, each of the context records has a respective pattern of context values corresponding to one or more context features, and thus the context patterns are based on the specific combination of the features and/or their corresponding values. More specifically, different context patterns may be determined based when the differences among the context features/values of one or more context records differ from one or more other context records. The degree of difference (e.g., the number of features among a group of context records that are not similar) can be predetermined and used to differentiate one context pattern from another. In certain embodiments, one or more of the features may be specified as a mandatory match (e.g., a different context pattern is determined only if the mandatory features do not match) or that the features may be arranged in a hierarchy (e.g., one feature must not match before the next feature is determined).

Further, the number of the context features considered for differentiating context patterns may be varied. In other words, if there are n available context features, the user may select any one or more of the n context features in any combination for determining context patterns. Accordingly, if the user desires to obtain more detailed context patterns, more context features may be considered. For example, the context features available for inclusion in a context pattern may include “day of the week”, “time of day”, and “mode of travel”. A more detailed context pattern can be constructed by utilizing all three features; whereas a less detailed context pattern can be constructed by choosing, for instance, two of the three available context features (e.g., clay of the week, and time of day). Although the various embodiments are discussed with respect to clustering-based algorithms, it is contemplated that the context segmenting platform 103 may use any algorithm or procedure for determining context patterns from the context information.

In one embodiment, the determined context patterns represent patterns that potentially match one or more of the context records. The determined context patterns support, for instance, the determination of transition points between the patterns as discussed previously. In another embodiment, the context patterns are determined from historical context information associated with the UE 101 and/or the user. In this case, the determined context patterns represent one or more context patterns that have already occurred with respect to the UE 101 or the user. By using historical context information (as opposed to context information that is currently to be processed), the context segmenting platform 103 may determine a broader range of possible context patterns for the user.

By way of example, one or more of the algorithms (e.g., the LDAC model) for determining context patterns may include generating vectors to determine clusterings or groups of the context information or records. Generating vectors, for instance, enables the context segmenting platform to more easily extract a subset of context features (e.g., high level feature) from the context information and reduce potential noise in the data. In step 305, the platform 103 determines whether vectors are to be used in the clustering algorithm. If no vectors are used, then the transition points between context patterns are determined directly from the context information (step 307). By way of example, clustering of raw contextual data may be performed using semantic or linguistic analysis of the context features and their corresponding values.

If the algorithm to be used by the context segmenting platform 103 is based on vectors, the platform 103 determines to generate the one or more vectors based, at least in part, on the one or more context patterns (step 309). For example, the LDAC model for clustering represents a context pattern by an n-dimensional vector of raw context data, wherein n indicates the total number of context feature value pairs captured in the context records. As described above, either the historical context information or the current context information can then be used to train the vectors. Accordingly, the context segmenting platform 103 can determine the probabilities or relative weights for the one or more dimensions (e.g., each dimension representing one of the determined context patterns) based on context patterns observed with respect to the UE 101 or the user. For example, the context segmenting platform 103 can identify the frequencies at which the context patterns occur in the context information. Based on these frequencies, the context segmenting platform 103 can determine the relative weights by, for instance, increasing the weight of dimensions corresponding to context patterns with higher frequencies. It is contemplated that the context segmenting platform 103 may apply any procedure or algorithm to determine the relative probabilities or weights of the dimensions based on context patterns occurring in the context information.

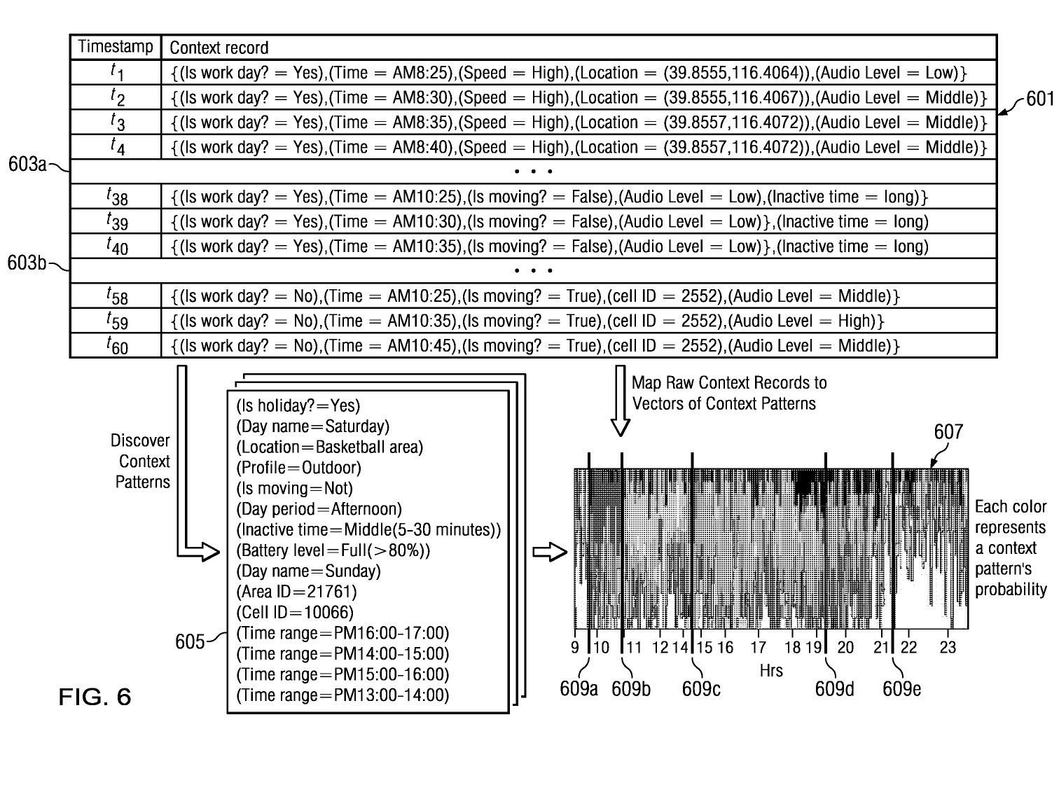

Then, in step 311, the context segmenting platform 103 determines to map the context information to the one or more vectors based, at least in part, on the one or more context patterns. For example, in one sample use case, the context segmenting platform may determine five context patterns CP1, CP2, . . . CP5 from context information associated with a particular user. Each raw context record can be mapped to a 5-dimensional vector where the i-th dimension denotes the weight of CPi in the context record. In one embodiment, the context record is mapped by determining the probability that the context feature values of the context record matches the context features of the candidate context pattern. This probability is then stored in the corresponding dimension of the vector. In one embodiment, when the probabilities of all of the dimensions are calculated, the direction of the vector with respect to the dimensions is indicative of the most closely matching context pattern. In addition, the probability profile of the dimensions of the vector can also be used to identify the most similar context pattern as discussed with respect to the FIG. 6 below.

Based on the mapping of the context information or records, the platform 103 can, for instance, determine the transition points between the context patterns occurring in the context information (step 313). More specifically, the context segmenting platform 103 places the mapped context vectors into a sequence based on, for instance, timestamp information associated with the corresponding context record. The platform 103 then applies one or more algorithms for identifying transition points in the vectors. By way of example, one example of such an algorithm is TextTiling (e.g., as described in “TextTiling: Segmenting Text into Multi-Paragraph Subtopic Passages,” Marti A. Hearst, Computation Linguistics, March 1997). The TextTiling algorithm uses, for instance, a sliding window on the sequence of vectors and calculates a depth score of each vector or data point. If the depth score is greater than a predetermined threshold value, the context segmenting platform 103 identifies the point as a transition point. In this case, the depth score increases as the differences in the vectors values increase (e.g., indicating a change or transition in the underlying context pattern). In one embodiment, the method for calculating a depth score for a point of a sequence of context pattern vectors is as follows:

depth(i)=max{(sim(i−1)−sim(i)),0}+max{(sim(i+1)−sim(i)),0}

### Where

$$sim ( i ) = \frac{{\sum }_{i} {w}_{t , {b}_{1}} {w}_{t , {b}_{2}}}{\sqrt{{\sum }_{t} {w}_{t , {b}_{1}}^{2} {\sum }_{t} {w}_{t , {b}_{2}}^{2}}}$$

Where w indicates the weight of a vector dimension.

In one embodiment, the context segmenting platform 103 continues to process the sequence of context pattern vectors and identifies transitions points when the depth score for the corresponding context pattern vector exceeds the predetermined threshold. In some embodiments, it is also contemplated that any other algorithm (e.g., a probability model) may be used to distinguish a large enough change from one context vector to another to indicate a transition point from one context pattern to another.

After determining the transition points, the context segmenting platform 103 segments the context information accordingly (step 315). For example, the context creates segments of the context information wherein the transition points comprise the ends of the segments. In one embodiment, the context segmenting platform 103 performs the segmentation without user intervention. In another embodiment, the context segmenting platform 103 may present the determined transition points and/or segments to the user for confirmation or modification.

FIG. 4 is a flowchart of a process for tagging segmented context information, according to one embodiment. In one embodiment, the context segmenting platform 103 performs the process 400 and is implemented in, for instance, a chip set including a processor and a memory as shown FIG. 10. In addition or alternatively, the process 300 may be wholly or partially performed by the context application 107. The process 400 assumes that the process 300 of FIG. 3 has been completed and one or more transition points have been identified in the context information.

In step 401, the context segmenting platform 103 determines to present a request specifying one or more context tags or labels for at least one of the one or more transition points. In one embodiment, the context labeling can be conducted online or offline. In the online mode, once the context segmenting platform 103 detects that the user's context has changed (e.g., by determining a transition point from the context information), a reminder dialog will pop up to ask the user to provide a tag to the current context transition point or context pattern. In other words, the context segmenting platform 103 determines to present a request to specify the one or more context tags when at least one of the transition points is determined. In some embodiments, the context segmenting platform 103 has a predefined list of context tags such as “Waiting a bus”, “Having a class”, and “Having a lunch.” In addition or alternatively, the user can also edit or personalize the context tags such as “Shopping at my favorite mall.” In the offline mode, the context segmenting platform 103 stores the detected time points of context transitions and reminds the user to label them after a period of time. In this case, the context segmenting platform 103 provides, for instance, a user interface to show the details of detected time points of context transitions, so the user can remember the corresponding context easily.

Next, the context segmenting platform 103 receives an input (e.g., from the user) for specifying one or more context tags or labels for at least one of the one or more transition points (step 403). As described above, the user can provide the input by specifying the context label from a predefined list or a personalized list of labels. In some embodiments, the context segmenting platform 103 may recommend one or more labels based on, for instance, the user's previous tagging sessions. For example, the user interface of the request can include presenting at least a portion of the context information associated with the one or more stored transition points, one or more recommended tags, or a combination thereof. Once the detected transition points are labeled, the context segmenting platform 103 can automatically label the context information by determining to associate the one or more specified context tags to a portion of the context information or context records occurring between the one transition point and an adjacent transition point (step 405). In other words, the platform 103 can automatically label the raw context records because the context records between two transition points can share the same context tag. Thus, the context segmenting platform 103 can automatically specify labels for many context records just by specifying labels for the associated transition points.

In some embodiments, the context segmenting platform 103 may also compute a probability factor for each of the determined transition points and/or context patterns as a measure of the ability of the respective context transition point or segment to discriminate the determined context pattern from other context patterns. In other words, the differentiating factor measures how well or how specific the context segment or pattern is to the corresponding portion of the context information.

When the context segments are determined, the segments may be used to initiate or provide specific services or tasks. In one embodiment, the context segmenting platform 103 may be apply the determined context segments to user segmentation, personalized recommendations, targeted advertising, etc. For example, if a context segment indicates that the user is on the phone whenever the moving speed of the UE 101 is high, this may show that the user may be on the phone whenever he is driving. Then, a recommendation can be made to the user to purchase a Bluetooth headset or other related products or services. As another example, a user who takes pictures at night in a loud environment at a busy part of a city may indicate that the user goes out to enjoy nightlife, and thus coupons for bars and nightclubs may be sent to the user.

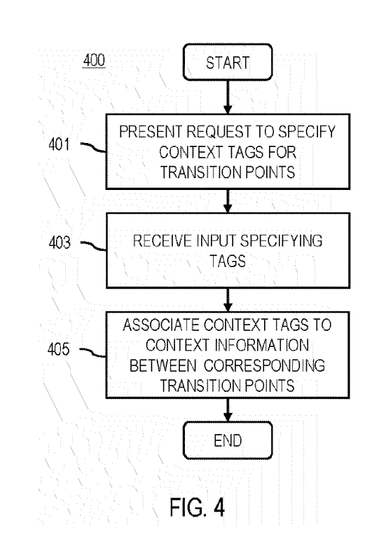

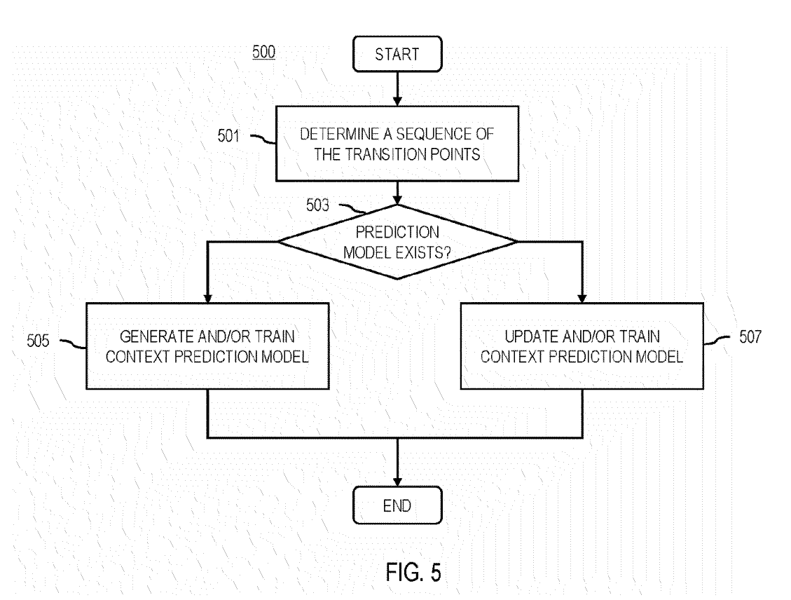

FIG. 5 is a flowchart of a process for context prediction using segmented context information, according to one embodiment. In one embodiment, the context segmenting platform 103 performs the process 500 and is implemented in, for instance, a chip set including a processor and a memory as shown FIG. 10. In addition or alternatively, the process 300 may be wholly or partially performed by the context application 107. The process 500 assumes that the process 300 of FIG. 3 and the process 400 of FIG. 400 have been completed to segment a set of context information or records.

In step 501, the context segmenting platform 103 determines a sequence of the determine transition points and/or segments. By way of example, the sequence may be analyzed to form a model that can be used to predict user actions in a certain context (e.g., a context prediction model). The prediction can then be used to provide recommendations to the user based on the anticipated context. This feature is advantageous in that a user tends to pay more attention to specific recommendations or advertisements than to general recommendations or advertisements. General recommendations or advertisements often contain information that is of no or limited interest to the user, thereby wasting limited computational resources, bandwidth, memory, power, etc. of the user's device. Consequently, identifying or predicting user contexts can advantageously reduce or provide more efficient use of such resources. Further, the user typically has to browse through a large volume of general information to find recommendations or advertisements that interest the user. The specific recommendations or advertisements based the user context segments would save the user effort and burden of finding recommendations or advertisements of user interest.

Accordingly, after determine the sequence of transition points and/or segments, the context segmenting platform 103 determines whether a context prediction model already exists for a particular user (step 503). If no context prediction model exists, the context segmenting platform 103 generates and/or trains the context prediction model (step 505). If the context prediction model exists, the platform 103 can use the determined sequence to update and/or train the existing context prediction model (step 507). As discussed, context prediction models can be used for learning a transition model between contexts from a sequence of segmented raw context data. In one embodiment, context prediction models can be extended from classical sequential models such as Markov model, Hidden Markov Model, or N-gram models. The automatic context segmentation approach described herein can then be used for preparing the training data for context prediction models. For example, with a trained personalized context recognition model, a user can subscribe to one or more context-aware applications with a personalized context, such as “Send sports news to me when I am on the way to work on a bus.”

As previously noted, the context recognition and/or prediction models can also be used to learn a user's intentions with respect to content, advertising, preferences, functions, etc. For example, with respect to any recognized or predicted context segment, the context segmenting platform 103 can detect or otherwise record user historical behavior with respect to, for instance, a particular content, advertising, function, preference, etc. More specifically, the context segmenting platform 103 determines what content, etc. the user is accessing or has accessed during a particular context segment (e.g., based on the determined sequence of transition points). In one embodiment, the context segmenting platform 103 also determines the user feedback with respect to the accessed content. By way of example, the user feedback may include how long the user views or accesses the content, any ratings the user provides for the content, whether the user shares the content with other users, etc. Based on this historical information, the context segmenting platform 103 may further train the context prediction model based, at least in part, on the accessed content. The model, for instance, may include statistical and/or other rule/data mining processes for determining the types of content, advertising, applications, etc. that a user is more likely to access during a particular context segment.

In another embodiment, the context segmenting platform 103 can determine what other content to present at the UE 101 based, on the content-trained context prediction model. For example, the context segmenting platform 103 can advantageously generate information for more specifically targeting content, advertising, etc. to users, thereby reducing the amount of resources (e.g., computing resources, bandwidth, memory, etc.) that would otherwise be expended for transmitting or providing potentially irrelevant content. In addition, content that is more accurately tailored to a specific user can capture greater interest from the user and be more effective.

FIG. 6 is a diagram depicting a vector-based process for segmenting context information, according to one embodiment. More specifically, FIG. 6 summarizes the processes described with respect to FIGS. 3-5 by illustrating the main steps of the approach described herein. First, in one embodiment, the context segmenting platform 103 uses an unsupervised approach, such as LDAC or K-means as discussed previously, to process the raw context records 601. In this example, the raw context records 601 include two transition points 603a and 603b that delineate distinct context patterns. Next, the context segmenting platform 103 uses the processes described with respect to FIGS. 3 and 4 to discover the context patterns 603 in the raw context records 601. The context segmenting platform 103 then generates multidimensional vectors of the determined context patterns 603 and maps the raw context records 601 to the vectors.

As noted previously, the context vectors represent the probabilities that any individual context record matches respective ones of the context patterns. The chart 607 is a graphical depiction of the sequence of mapped context vectors arranged in chronological order. Each narrow band of the chart 607 represents a context record and the respective colors or shades of each of the narrow bands represent a particular context pattern's probability of matching the context record. The context segmenting platform 103 can then use a segmentation algorithm such as TextTiling to segment the context record sequence of the user. The segmentation algorithm identifies transition points 609a-609e in the raw context records 601. The difference in shading of the context records in the chart 607 is indicative of transition points. With the context segmentation approach, a context labeling system can remind the user to label around the time points of context transition. Then the context data between two transition time points can share the same label. In the end, the collected context data with labels are used for training a personalized context recognition model.

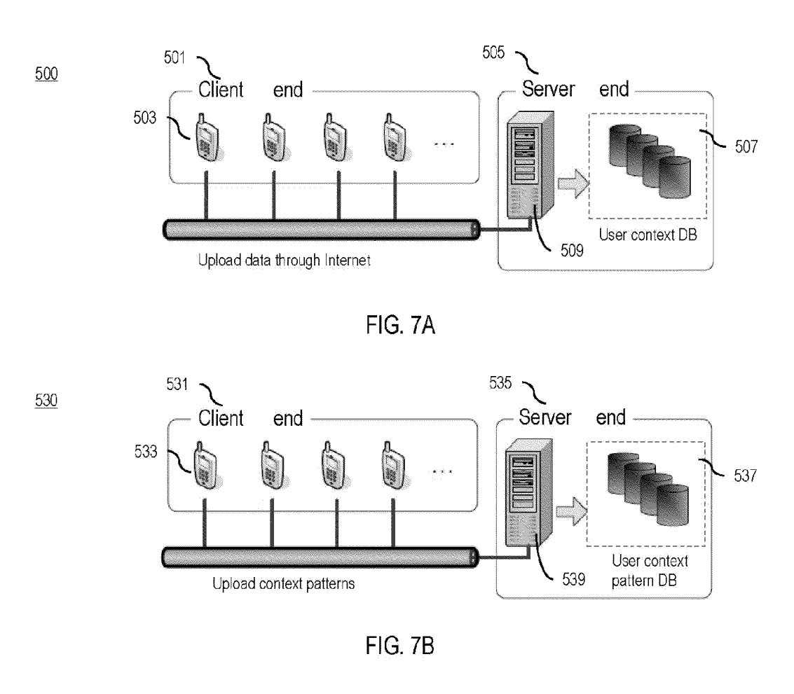

FIGS. 7A and 7B are diagrams of interactions between a client and a server utilized in segmenting context information, according to various embodiments. FIG. 7A shows that data such as context records retrieved at the client end 701 from mobile devices 703 (e.g., UEs 101a-101n), may be uploaded to the server end 705 through the Internet (e.g., communication network 105). In one embodiment, the server end 705 may include the context segmenting platform 103 and/or the service platform 113. At the server end 705, the uploaded data is stored in the user context database 707. This embodiment is advantageous in that the mobile devices 703 can reduce their computational burdens associated with segmenting context information by transferring or sharing the burden with the server 709. It is noted that the server 709 generally has more processing power and related resources (e.g., bandwidth, memory, etc.) than the mobile devices to handle this type of computation. Alternatively, as shown in FIG. 7B, the data retrieved by the mobile devices 733 at the client end 731 may be stored at storage media (not shown) of the respective mobile devices 733. The mobile devices 733 may then locally perform the computations for determining, for instance, the context patterns or segments from the context data. Then, the result of the computation (e.g., the context patterns, transition points, context segments) may be uploaded to the server end 735 including a server 739 and user context pattern database 737. This embodiment is advantageous in that the data is kept within the respective mobile devices 733, and is not uploaded to other devices or servers without the user's permission. Thus, this embodiment in FIG. 7B provides a higher level of privacy protection. In addition, for both embodiments in FIGS. 7A and 7B, the user of the mobile device may configure a privacy setting to determine whether any data retrieved from the mobile device can be sent to the server end 735. Further, although not shown, much of the analysis of the context segmentation according to this invention may be performed within the mobile device 733 even when the mobile device 733 is not connected to the server 739. As long as the mobile device 733 has the data and sufficient processing power to analyze the data, then the server 739 may not be required to perform the analysis.

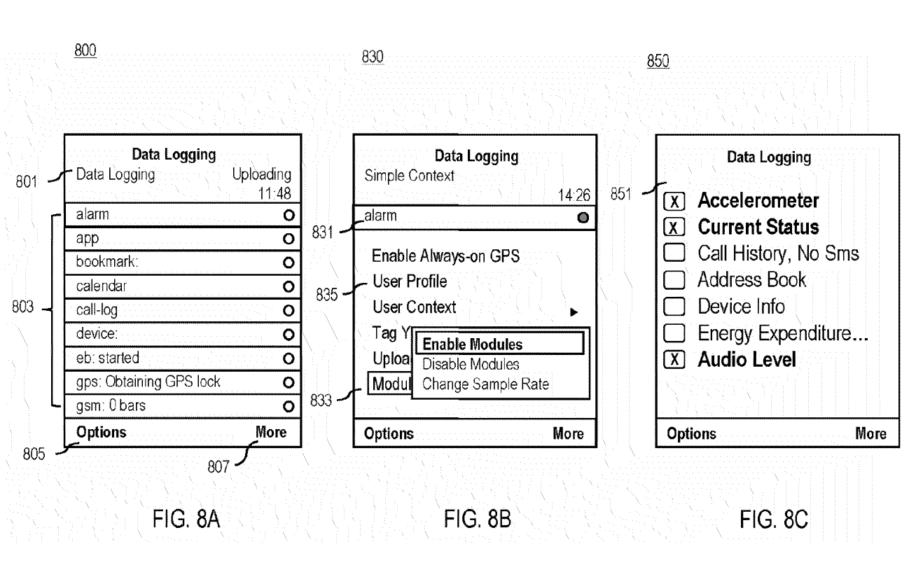

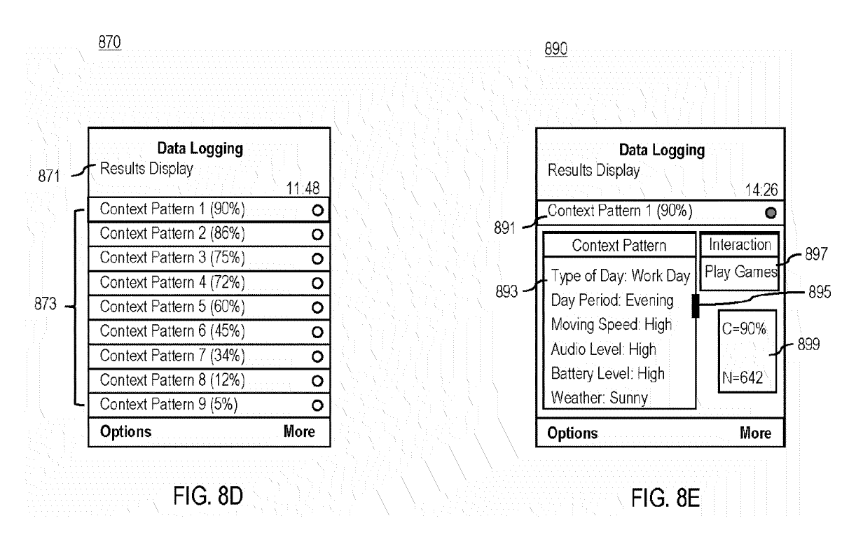

FIGS. 8A-8E are diagrams of user interfaces at a client end utilized in the processes of FIGS. 3-5, according to various embodiments. FIG. 8A shows a user interface 800 of a mobile device. The information window 801 shows that the user interface for “data logging” and related information, and further shows that context records are in the process of being uploaded. The list 803 shows the available context features that can be selected to be configured in the context records for uploading. The options 805 provides additional options (e.g., privacy filters, searches, etc.) that can be configured and the more option 807 may be selected to show additional context features that can be configured.

FIG. 8B shows a user interface 830 showing configuration options for context features available at the mobile device. In the example shown in FIG. 8B, alarm 831 is selected to be configured. Once alarm 831 is selected, expandable menu 833 is displayed. In this example the alarm 831 activates on the detection of a specific context pattern or transition point. The user can browse and select among the menu options 835 to specify the particular context pattern or transition point. In this example, module option 833 is selected, which further displays additional options to enable modules, to disable modules or to change sample rate for gathering alarm-related context information. FIG. 8C shows a user interface 850 that enables a user to choose data sources or sensors for collection of context records. The context menu 851 shows a list of context features or context sources from which context records can be collected. In the example shown in FIG. 8C, Accelerometer, Current Status and Audio Level are selected. Thus, the context records retrieved from this mobile device will include these three context features.

FIG. 8D depicts a user interface 870 for displaying determined context patterns and their respective confidence values. As shown, the information window 871 identifies that the user interface 870 is for “Results Display.” Moreover, the user interface 870 presents a list of context patterns 873 stored in a descending order of confidence values. One of these context patterns may be selected to display more details about the context patterns, as shown in the user interface 890 of FIG. 8E. In the example of FIG. 8E, Context Pattern 1 891 is selected to display additional details. Accordingly, the context pattern window 893 displays context features corresponding to Context Pattern 1. The context pattern window 893 also has a scroll 895 to scroll up and down the context pattern window 893. The interaction window 897 displays what interaction is matched with Context Pattern 1. The confidence window 899 shows a confidence value and a number of context records considered in computing the confidence. In this example, the confidence window 899 shows the confidence of 90% and that 842 context records were considered to compute the confidence.

The processes described herein for segmenting context information may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

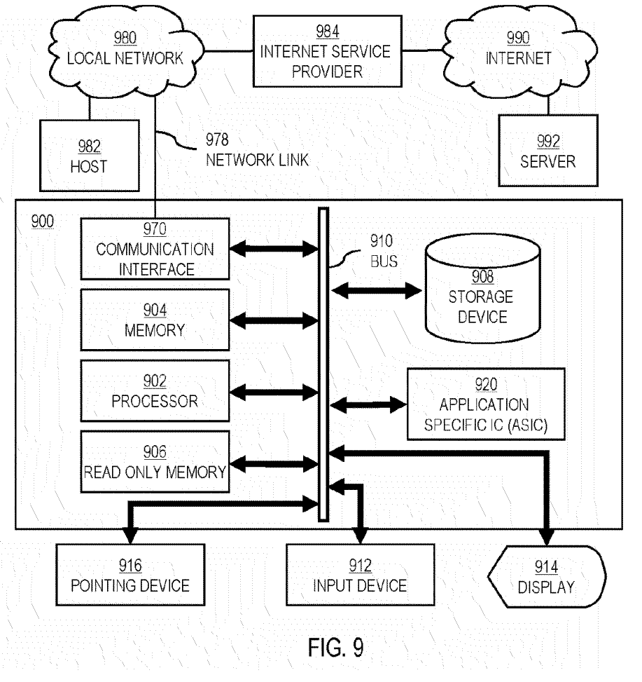

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to segment context information as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of segmenting context information.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to segmenting context information. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for segmenting context information. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for segmenting context information, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for segmenting context information.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to segment context information as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of segmenting context information.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to segment context information. The memory 1005 also stores the data associated with or generated by the execution of the inventive steps.

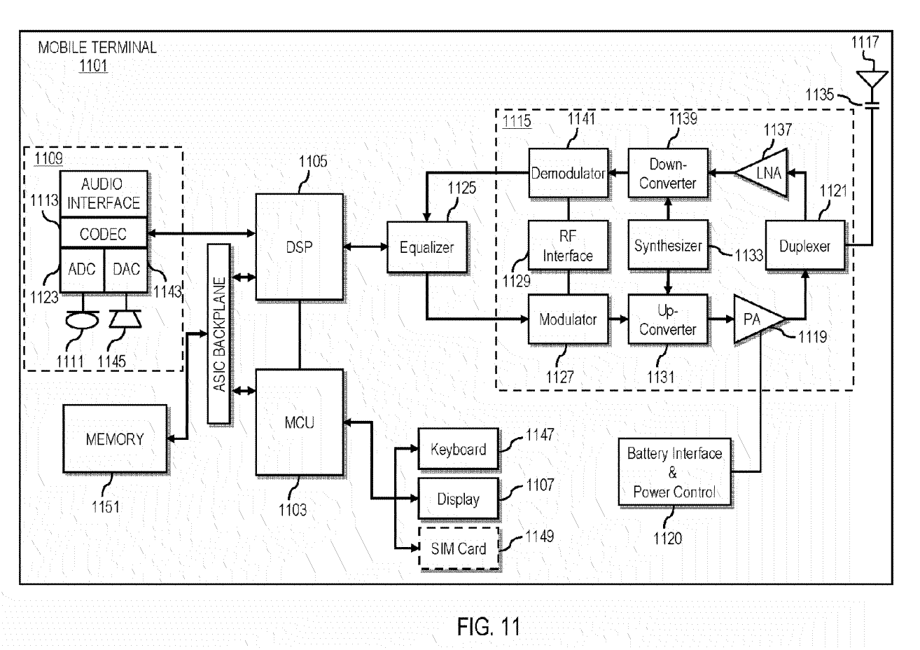

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of segmenting context information. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of segmenting context information. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to segment context information. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining context information associated with a device;
determining one or more context patterns based, at least in part, on the context information;
determining one or more transition points between the one or more context patterns; and
determining to segment the context information based, at least in part, on the one or more transition points.

2. A method of claim 1, further comprising:
determining to map the context information to one or more vectors based, at least in part, on the one or more context patterns,
wherein the determining of the one or more transition points is based, at least in part, on the mapped context information, the one or more vectors, or a combination thereof.

3. A method of claim 2, wherein the one or more vectors have one or more dimensions that represent the one or more context patterns, the method further comprising:
determining relative weights for the one or more dimensions based, at least in part, on a comparison of at least a portion of the content information to the corresponding one or more context patterns; and
determining to generate the one or more vectors based, at least in part, on the relative weights.

4. A method of claim 1, further comprising:
determining respective probabilities that the one or more context patterns represent at least a portion of the context information;
wherein the determining of the one or more transition points is based, at least in part, on the respective probabilities.

5. A method of claim 1, further comprising:
receiving an input for specifying one or more context tags for at least one of the one or more transition points; and
determining to associate the one or more context tags to a portion of the context information occurring between the at least one transition point and an adjacent transition point.

6. A method of claim 1, further comprising:
determining to present a request to specify one or more context tags when at least one of the one or more transition points is determined.

7. A method of claim 1, further comprising:
determining to store the one or more transition points; and
determining to present a request to specify one or more context tags for the one or more stored transition points.

8. A method of claim 1, further comprising:
determining a sequence of the one or more transition points;
determining to generate or to train a context prediction model based, at least in part, on the sequence.

9. A method of claim 8, further comprising:
determining content accessed at the device with respect to the sequence,
wherein the context prediction model is further trained based, at least in part, on the accessed content.

10. An apparatus comprising:
at least one processor; and
at least one memory including computer program code,
the at least one memory and the computer program code configured to, with the at least one processor, cause the apparatus to perform at least the following,
determine context information associated with a device;
determine one or more context patterns based, at least in part, on the context information;
determine one or more transition points between the one or more context patterns; and
determine to segment the context information based, at least in part, on the one or more transition points.

11. An apparatus of claim 10, wherein the apparatus is further caused to:
determine to map the context information to one or more vectors based, at least in part, on the one or more context patterns,
wherein the determining of the one or more transition points is based, at least in part, on the mapped context information, the one or more vectors, or a combination thereof.

12. An apparatus of claim 11, wherein the one or more vectors have one or more dimensions that represent the one or more context patterns, and wherein the apparatus is further caused to:
determine relative weights for the one or more dimensions based, at least in part, on a comparison of at least a portion of the content information to the corresponding one or more context patterns; and
determine to generate the one or more vectors based, at least in part, on the relative weights.

13. An apparatus of claim 10, wherein the apparatus is further caused to:
determine respective probabilities that the one or more context patterns represent at least a portion of the context information;
wherein the determining of the one or more transition points is based, at least in part, on the respective probabilities.

14. An apparatus of claim 10, wherein the apparatus is further caused to:
receive an input for specifying one or more context tags for at least one of the one or more transition points; and
determine to associate the one or more context tags to a portion of the context information occurring between the at least one transition point and an adjacent transition point.

15. An apparatus of claim 10, wherein the apparatus is further caused to:
determine to present a request to specify one or more context tags when at least one of the one or more transition points is determined.

16. An apparatus of claim 10, wherein the apparatus is further caused to:
determine to store the one or more transition points; and
determine to present a request to specify one or more context tags for the one or more stored transition points.

17. An apparatus of claim 10, wherein the apparatus is further caused to:
determine a sequence of the one or more transition points;
determine to generate or to train a context prediction model based, at least in part, on the sequence.

18. An apparatus of claim 17, wherein the apparatus is further caused to:
determine content accessed at the device with respect to the sequence,
wherein the context prediction model is further trained based, at least in part, on the accessed content.

19. A computer-readable storage medium carrying one or more sequences of one or more instructions which, when executed by one or more processors, cause an apparatus to perform:
determining context information associated with a device;
determining one or more context patterns based, at least in part, on the context information;
determining one or more transition points between the one or more context patterns; and
determining to segment the context information based, at least in part, on the one or more transition points.

20. A method comprising facilitating access to at least one interface configured to allow access to at least one service, the at least one service configured to perform: determining context information associated with a device;
determining one or more context patterns based, at least in part, on the context information;
determining one or more transition points between the one or more context patterns; and
determining to segment the context information based, at least in part, on the one or more transition points.
